(19) United States
(12) Patent Application Publication
(10) Pub. No.: US 2007/0272811 A1
(43) Pub. Date: Nov. 29, 2007

(54) Roof safety device

(76) Inventor: Kent H. Baake, Alexandria, VA (US)

Correspondence Address: BLANKENSHIP LAW, PLLC, 2815 HARTLAND ROAD, SUITE 120, FALLS CHURCH, VA, 22043, US

(21) Appl. No.: 11/702,985

(22) Filed: Feb. 6, 2007

Related U.S. Application Data
(63) Continuation-in-part of application No. 11/438,865, filed on May 23, 2006.

(51) Int. Cl. A62B 35/00

(52) U.S. Cl. 248/237

(57) ABSTRACT

The present invention is directed to a low-profile roof safety device, and kit of parts therefor, for grasping the apex or edge of an angled roof. The roof safety device includes a body with frictional contact surfaces, a cord, and a harness. Unlike previous roof safety devices, the present invention does not require puncturing the exterior of a roof for stability.

### CROSS REFERENCE TO RELATED APPLICATIONS

This is a Continuation-In-Part of U.S. application Ser. No. 11/438,865 filed May 23, 2006.

### FIELD OF THE INVENTION

The present invention relates to the field of roof safety and more specifically to the field of non-destructive devices to support a user on a roof.

### BACKGROUND

The average consumer dreads maintenance, cleaning, and renovations; particularly when such work is required at great heights. As proof of a consumer's dread of heights, one need only examine the massive service industry involving roof and gutter maintenance. Roof and gutter maintenance is important, and should be done frequently. Labor at great heights is best accomplished by one with good balance.

Clogged gutters can wreak havoc on a home and the surrounding property. Standing water creates a great habitat for birds, bees, insects, termites, and rodents. Overflowing water from a clogged gutter rots certain types of wood, and water spilling from the gutter to the base of a house can erode the nearby ground and cause serious foundation damage to the house. Gutters, depending upon the presence of nearby foliage, should be cleaned between two and four times per year. Because of the great danger of amateurs on a roof, a gutter ought to be cleaned by a professional who frequently works at substantial heights.

For the majority of one story houses, a professional asked to clean a gutter will arrive with merely a ladder and fearlessness acquired from the constant high altitude work. However, there are some instances in which a ladder will not suffice. Regulations sometimes prohibit the use of ladders in specific areas; or perhaps a common ladder would simply be inconvenient to use. In such instances there should be a secondary device that supports a user on a roof.

There are many times when a maintenance worker requires stable access to a roof surface. Anyone attempting to maintain a chimney, repair or replace a window, or install or maintain siding could use a roof support device. Multiple examples of roof support devices exist. Supporting the body weight of user on a sloping surface is a complicated matter; information relevant to attempts to address roof support can be found in U.S. Pat. Nos. 3,292,734; 4,942,943; 5,143,171; 5,287,944; 5,730,407; 5,896,719; 6,216,819; and 6,668,509. However, each one of these references suffers from one or more of the following disadvantages: inadequacy; setup complexity; requirements of roof puncturing; lack of portability; lack of adaptability; and high visibility.

Therefore, there is a need for a roofing safety device that: does not require substantially long periods of time to assemble, move, and adjust; or does not require a user to puncture a roof to set up the safety device. Furthermore, the safety equipment should be portable, adjustable, and not attract unwanted attention to the house being serviced.

### SUMMARY

The present invention is directed to a low-profile roof safety device for grasping a roof, whether it be the apex of the roof or the edge of the rood. Components of the roof safety device include a body with a frictional contact surface, a cord, and a harness. The body of the roof safety device includes a stabilizer and an anchor. In a static (i.e. non-moving) embodiment of the present invention, the anchor is connected to the stabilizer in a substantially perpendicular configuration, which allows the shape of the device to urge the frictional contact surface into frictional connection with a roof, and utilize the inherent grasping abilities of a right angle (and angles substantially similar). In a rotatable embodiment of the present invention, the stabilizer is rotatably connected to the anchor in a manner that allows rotation about a plane. The rotation allows the rotatable embodiment of the present invention to be more easily adapted to different types of roofs and allow connection of the device to the edge of a roof.

Disposed upon the bottom of the body certain of embodiments of the present invention, i.e. the portion of the device that would contact the roof, is the frictional contact surface. The purpose of the frictional contact surface is to allow the weight and shape of the body to grasp a roof without physically affixing the body to the roof. The frictional contact surface has a surface that contacts a roof to allow the force of gravity to maintain a user attached to the safety device. The frictional contact surfaces achieve gravitational stability because the exterior of the frictional contact surface includes a material with a high coefficient of static friction with respect to a roof surface.

The cord of the roof safety device attaches to the body and the harness. Both the cord and harness can be removed for storing the device in its individual components.

Therefore, it is an aspect of the present invention to substantially eliminate long periods of assembly, moving, and adjusting time.

It is a further aspect of the present invention to introduce a roof safety device that does not require a user to puncture a roof to set up the safety device.

It is a still further aspect of the present invention to introduce a highly portable roof safety device.

It is a still further aspect of the present invention to allow home maintenance without drawing unwanted attention to the maintained house.

It is a still further aspect of the present invention to present a roof safety device amenable to a great variety of roof pitches.

It is a still further aspect of the present invention to present a roof safety device capable of grasping the edge of a roof.

These aspects of the invention are not meant to be exclusive and other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is an isometric view of an embodiment of the roof safety device grasping a roof.

FIG. 2 is an isometric view of a preferred body arrangement of an embodiment of the roof safety device.

FIG. 3 is a top-down, orthogonal view of the body of an embodiment of the roof safety device.

FIG. 4 is a sectional, orthogonal view of the body of an embodiment of the roof safety device, as viewed from the arrow of FIG. 3, highlighting the anchor.

FIG. 5 is a bottom, orthogonal view of the body of an embodiment of the roof safety device.

FIG. 6 is a sectional, orthogonal view of the body of an embodiment of the roof safety device, as viewed from the arrow of FIG. 5, highlighting the portion of anchor dimensioned to contact a roof.

FIG. 7 is an isometric view of a unitary body embodiment of the roof safety device.

FIG. 8 is an isometric view of a unitary body embodiment of the roof safety device highlighting the portion of the body dimensioned to contact a roof.

FIG. 9 is an isometric view of an adjustable roof safety device embodiment.

FIG. 10 is an isometric view of an adjustable roof safety device embodiment disassembled.

FIG. 11 is a plan view of an adjustable roof safety device embodiment disassembled.

FIG. 12a is an isometric view of a body lock of the present invention positioned on the stabilizer. FIG. 12b is a plan, partial view of a body lock of the present invention.

FIG. 13 is an isometric view of an adjustable roof safety device embodiment.

FIG. 14 is an isometric view of an adjustable roof safety device embodiment.

### DETAILED DESCRIPTION

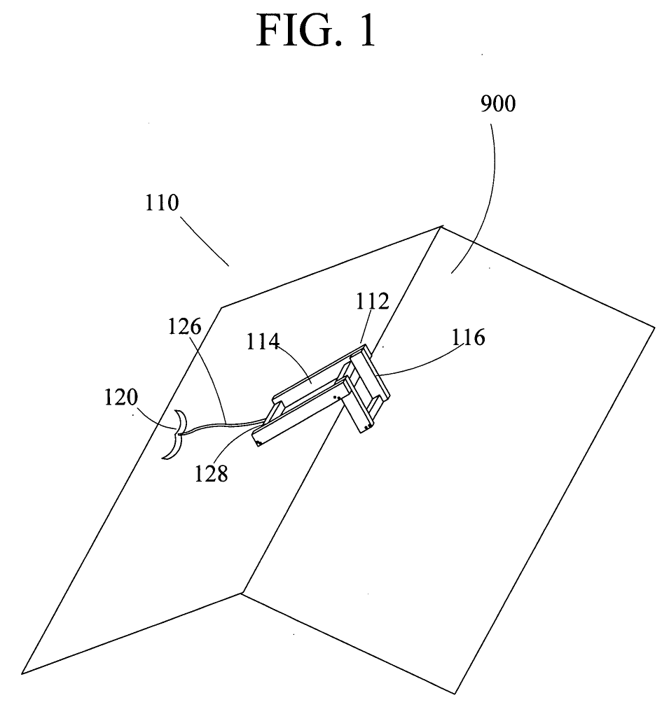

Referring first to FIG. 1, a static embodiment of the roof safety device 110 is shown grasping the apex of the two converging angled planes of a roof 900. By static embodiment, it is meant that the static embodiment is not configured for internal rotation. The roof safety device includes both static embodiments and adjustable embodiments. The roof safety device, though designed to work on a shingled roof, is not to be limited to that particular type of roof; any type of roof upon which the roof safety device can meaningfully fulfill the purposes of its uses will suffice. Certain embodiments of the static roof safety device 110 include a body 112 with frictional contact surfaces (not shown), a cord 126, and a harness 120. The body 112 includes a stabilizer 114 and an anchor 116, each is connected to the other to form a substantially perpendicular arrangement.

It is not necessary that the body be divided into two distinct components; a unitary body is within the bounds of the present invention. The body is discussed in two components within this disclosure for purposes of simplicity. Unless otherwise noted, the stabilizer 114 is understood to be the portion of the body to which the safety cord attaches, the anchor 116 is understood to be the portion of the body opposite of the stabilizer 116 that accepts the force of the user. For purposes of stability and traction, the stabilizer 114 is longer than the anchor 116. Stabilizers sized similarly to anchors hinder the gripping ability of the body causing the device to slip.

The length of the stabilizer 114 is preferably at least twice the length of the anchor 116 and not more than three times the length of the anchor 116. A stabilizer 114 having a length less than approximately twice the length of the anchor 116 causes the body 112 of the roof safety device 110 to slip while engaging a roof surface. Although a stabilizer 114 having a length greater than three times the length of the anchor 116 is capable of fulfilling certain safety purposes of the roof safety device, the additional weight is generally unnecessary to stabilize the average worker on a roof. A stabilizer 114 between two and three times the length of the anchor 116 is preferred because such a length ratio is believed to best combine the roof safety device's aspects of safety and portability. With the substantially perpendicular body arrangement having a differently sized anchor and stabilizer, the roof safety device is designed to work with roofs of any practicable angle, but especially for roofs having a pitch of between 15 degrees and 60 degrees.

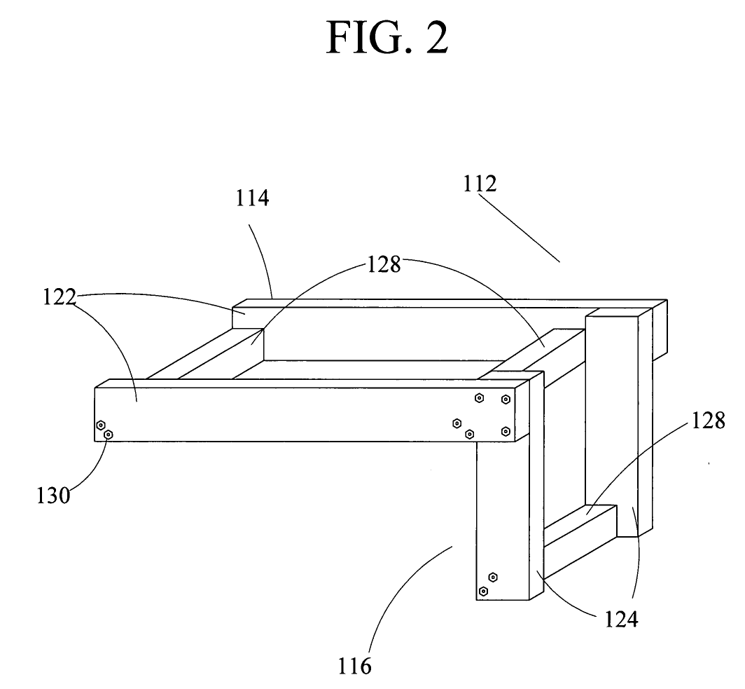

FIG. 2 illustrates the preferred body 112 configuration of the static roof safety device. The anchor 116 is connected to the stabilizer 114 in an L-shaped arrangement. This body embodiment features parallel anchor beams 124 and parallel stabilizer beams 122, each connected by bolts 130 to at least one support beam 128. Having an anchor 116 divided into two anchor beams 124 and a stabilizer 114 composed of two stabilizer beams 122 is preferred to a strictly unitary body construction because it allows a substantial amount of roof surface contact relative to the weight of the roof safety device. With either the anchor beams 124 or the stabilizer beams 122, there could be more than two; however, such is not preferred because of the necessarily corresponding increase in weight of the roof safety device body.

The substantially L-shaped arrangement conveys certain benefits unrelated to grasping a roof. The centralized, low-profile nature of the preferred L-shaped arrangement obscures the fact the roof safety device is attached to a roof, when it is attached. This bestows a commercial advantage to the user of the device, who can now maintain a roof or gutter without broadcasting to the neighborhood of the house that maintenance is occurring. Many maintenance devices are unsightly and draw unwanted attention; the low-profile nature of the roof safety device minimizes maintenance visibility.

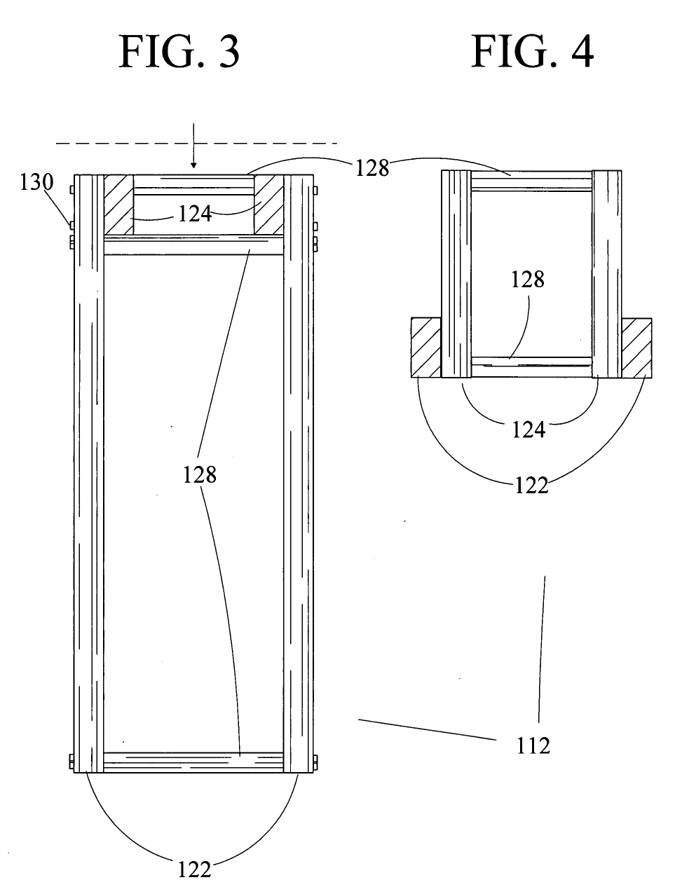

Now turning to FIG. 3, the body 112 of the embodiment of the roof safety device of FIG. 2 is shown from a top view. In particular, the preferred arrangement of the support beams 128 and the stabilizer beams 122 are shown. It is preferred that the body of the roof safety device be made of wood. Wood conveys certain frictional advantages, as will be explained later, to the body and its ability to maintain its position on the apex of a roof. However, an aluminum body would have several advantages over wood, such as ruggedness. FIG. 4 shows a sectional view of the embodiment of the roof safety device of FIG. 2 with special attention paid to the anchor support beams 124.

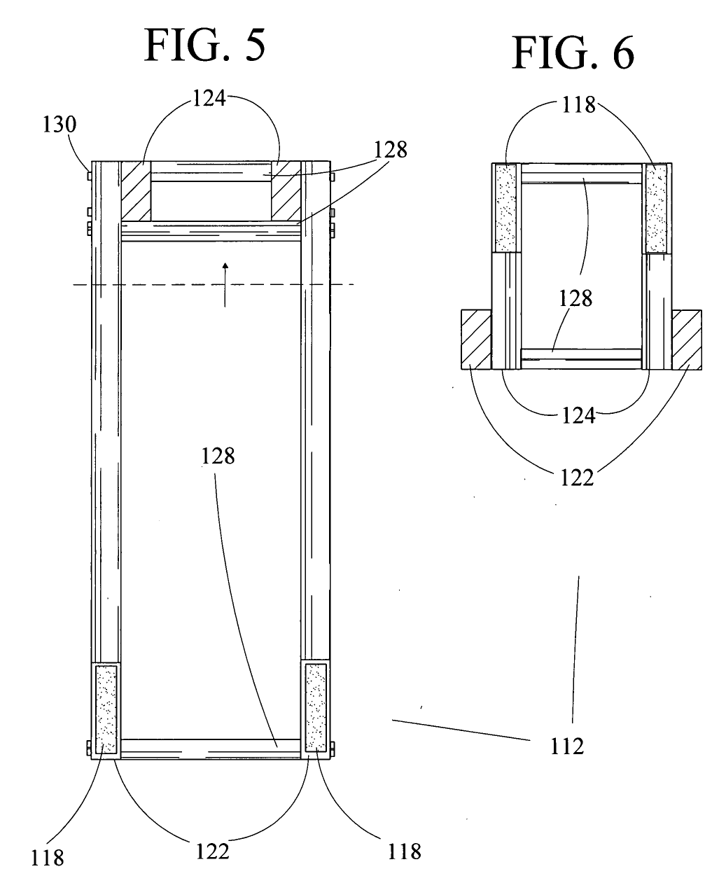

FIG. 5 illustrates the portion of the body, i.e. the bottom, of the roof safety device that would contact a roof. Upon the bottom of the body is the frictional contact surface 118. The frictional contact surface 118 allows the weight and shape of the body to grip a roof without physically affixing the body to the roof. The body does not require the use of nails, or other fasteners, to maintain a position on the apex of a roof. Because the frictional contact surface 118 has a high coefficient of static friction, relative to a roof surface, the force of gravity maintains a user connected to the body of the roof safety device. When the body of the roof safety device is constructed of wood, then there need not necessarily be an additional added surface other than the wood exterior as the frictional contact surface. In certain cases, the portions of the body that contacts a roof is the frictional contact surface. In other embodiments, such as metal embodiments, the metal would probably not have a coefficient of static friction necessary to maintain the body in an acceptably static position when attached to a user; a separate, distinct frictional contact surface would probably be necessary.

In all embodiments, the preferred frictional contact surface is grip tape. Grip tape is a flexible planar material, in either strips or sheets, that has adhesive on one side and a friction-inducing material on the other side. It is found that the grip tape commercially sold for skateboard maintenance works well, though other types of grip tape would work as well. The skateboard grip tape includes a rough, gritty material on the portion of the grip tape adapted to induce friction. However, any type of grip tape that would fulfill the purpose of the roof safety device will suffice. Additional materials suitable for the frictional contact surface include foams and plastics.

Foams and other materials possessing a substantial elasticity provide friction sufficient to adequate frictional contact with a roof. Due to its ability to withstand environmental challenges, the preferred foam for use with the present invention is one or more polyether strips. Plastics, additionally, contact roof surfaces in manner allowing for sufficient contact. Polyurethane, Neoprene, Vinyl Nitrile, Styrene-Butadiene Rubber, Polyethylene, ethyl vinyl acetate, ethylene propylene terpolymer), EPT/PE/ButylRubber, Neoprene/EPT/SBR, epichlorohydrin, and nitrile are among the types of materials that would provide adequate friction surfaces for use in the present invention.

The frictional contact surface bestows multiple advantages on the present invention. The roof safety device need not be affixed to a roof with a nail or similar puncturing device; therefore, the setup time to use the roof safety device is minimal. At its simplest, one need only remove the roof safety device from a vehicle, attach the harness, attach the cord, and then place the body on the apex of a roof. The difference between “placing” and “affixing” a large roof device can amount to many wasted minutes. Furthermore, by avoiding affixing the body of the roof safety device to a roof, the user of the device obviates the need to puncture the roof. After all, it is recommended that one clean a roof and gutter system, on average, between two and four times per year. The roof of a house has a life of at least a decade or two; the less holes the better.

FIGS. 5 and 6 show the preferred location of the frictional contact surface 118 on the preferred body. The frictional contact surface 118 is preferably apportioned among several locations; e.g. FIGS. 5 and 6 show frictional contact surfaces 118 on each stabilizer beam 122 and anchor beam 124 toward the extremities of the respective components. Other embodiments of the roof safety device might include a frictional contact surface solely on the stabilizer, or a frictional contact surface solely on the anchor.

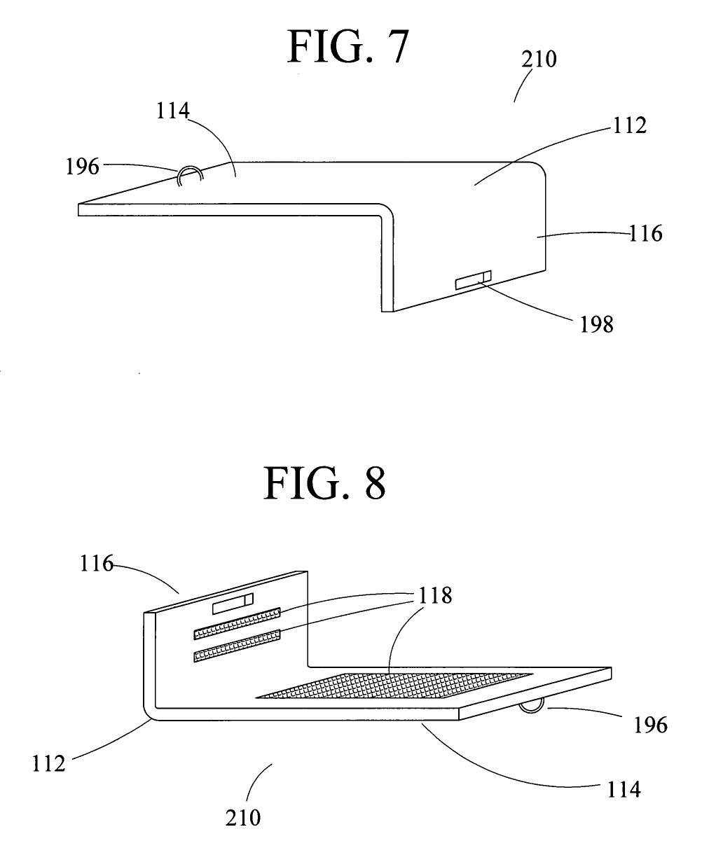

FIG. 7 illustrates the unitary body roof safety device 210 embodiment. The unitary body roof safety device 210 embodiment is particularly advantageous when the device is constructed of a metal, particularly those amenable to molding. Because it is harder to grip a unitary body than a body having multiple surfaces, the preferred unitary body possesses a body grip 198 handle integrated into, or onto, the body 112. Further disposed on, or integrated into, the body 112 of the device 210 is a hook 196 to accept the cord (not shown). As FIG. 8 shows, the frictional contact surface 118 is composed of a plastic, and is divided into multiple subunits.

Returning to FIG. 1, the cord of the roof safety device 110 attaches to the body 112. In the preferred embodiment as pictured, the cord 126 attaches to one the support beams 128, preferably to the support beam closest to the user, on the stabilizer 114. The cord 126 can be attached by a fastener or by simply tying the rope to the body 112. The preferred cord is a mountain climbing rope composed of a nylon material.

The harness 120 of the roof safety device 110 is any harness capable of supporting a human. It can include purely a waist strap, or a waist and shoulder strap. It is configured to be removed from the cord to allow the roof safety device to be stored in its individual components.

A kit of parts for the roof safety device is also envisioned. The roof safety kit includes the body, the frictional contact surface, the cord, and the harness. It is preferred that the kit include one body (with or without the frictional contact surfaces attached) having the preferred structure illustrated in FIG.2, one or more cords, one or more harnesses, and multiple strips of grip tape to either attached to the body or replace strips on the body when worn by use.

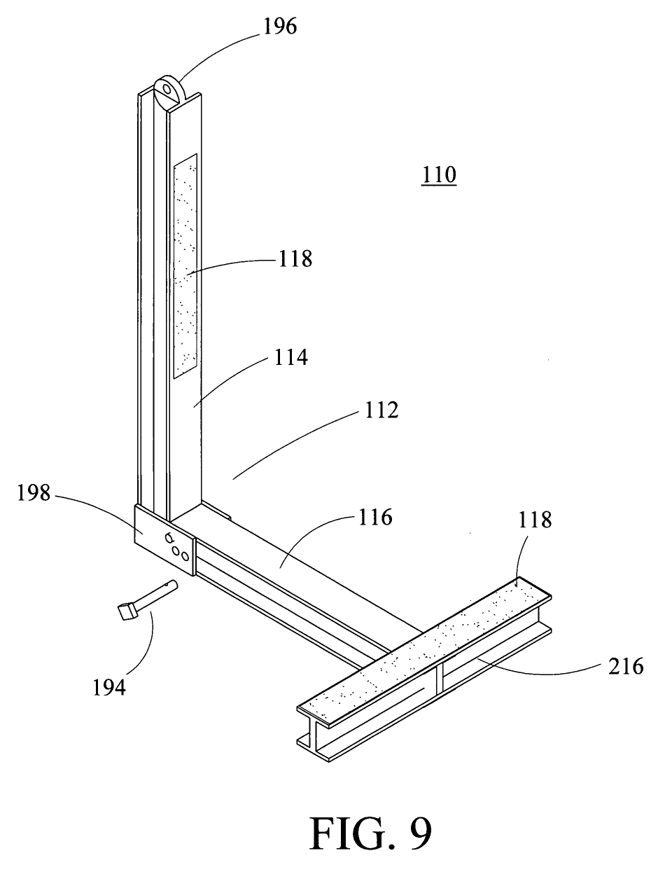

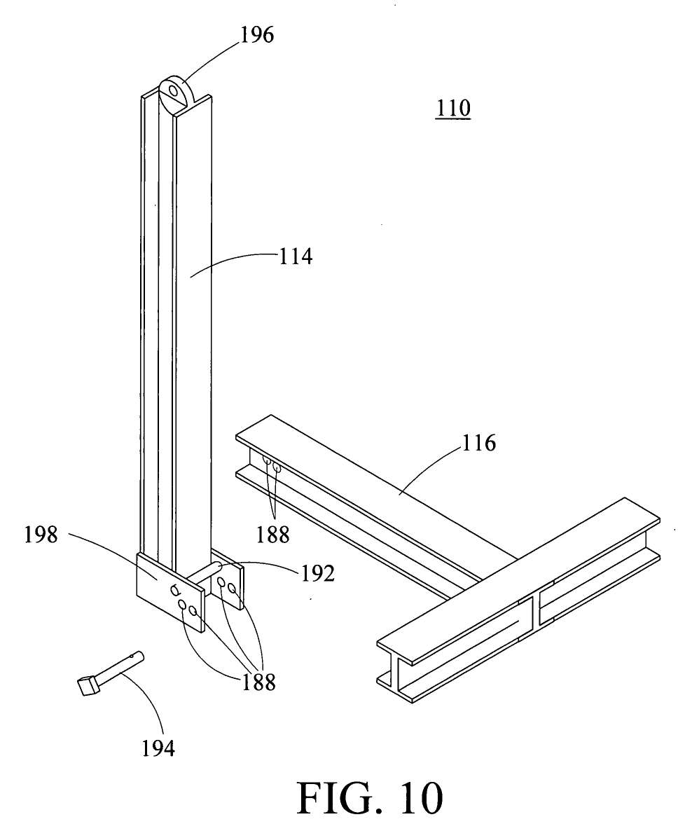

Turning to FIG. 9, the adjustable embodiment of the roof safety device 110 is shown. The adjustable roof safety device 110 shares many structural similarities with the static roof safety device, and any components of the static roof safety device can be applied to the adjustable roof safety device to the extent that the adjustable roof safety device remains rotatable between the anchor 116 and the stabilizer 118. The adjustable roof safety device 110, however, does include preferred configurations that differ from the static roof safety device, and are illustrated in FIGS. 9-14

FIG. 9 illustrates an embodiment of the adjustable roof safety device 110 suited to grasp the apex of a roof. It includes the body 122 which includes the stabilizer 114, the anchor 116, attachment means 196 for a harness cord, and a rotation lock 194. Embodiments further include one or more frictional contact surfaces 118, although other embodiments adapted to clasp a roof edge do not require the frictional contact surfaces.

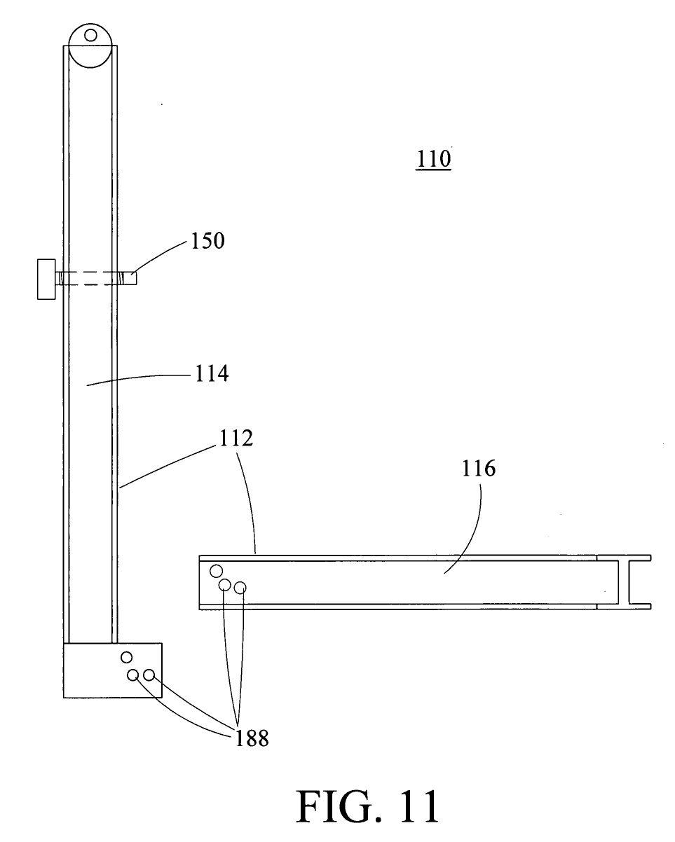

As FIG. 10 shows in greater detail, the anchor 116 and the stabilizer 114 of the adjustable roof safety device 110 are rotatably joined. In the embodiment of the device 110 pictured in FIG. 10, the rotation is achieved by use of a hinge joint 192 where a shaft is affixed to the stabilizer 114 that mates with apertures within the anchor 116, or vice versa. This preferred jointed fastening allows the device to rotate through a ninety degree (or greater) plane of travel, which allows the device to adapt to multiple pitches of roof tops. The preferred configuration of the rotation joint is a position that prevents the anchor 116 from contacting the stabilizer 114 during rotation, which allows the stabilizer to rotate to angles greater than 90 degrees, but less than 180 degrees, with respect to anchor. The jointed fastener is, however, merely the preferred rotation means; other rotatable fastening means capable of selective locking would similarly apply to the present invention.

As the adjustable roof safety device embodiment 110 requires a large degree of inherent stability, a rotation lock 194 is required. The adjustable roof safety device 110 must be capable of rotation about a plane, remaining in a set location, and tolerating stress urging deviation from that set location. The rotation lock acts to prevent such deviation. To that end, the rotation lock can be any device capable of maintaining a stationary position for the anchor 116 with respect to the stabilizer 114. The shown rotation lock includes a lock rod 194, a pair of adjustment plates 190 forming lock apertures 188, and lock apertures 188 within the anchor 116. In the illustrated preferred embodiment, the roof safety device 110 includes two sets of lock apertures; each set is configured such that the lock rod 194 can pass through a single adjustment plate 190 lock aperture 188, then through a single corresponding anchor lock aperture 188, and back out through another corresponding adjustment plate 190 lock aperture 188. It embodiments utilizing a lock rod 194, there is then a means for stabilizing the lock rod within the apertures, shown here as a depressible rod lock. Other rod locks could include a removable pin that attaches to the end of the rod lock. The rotation lock could include devices other than the illustrated rod lock; the present invention could encompass any locking means suitable to prevent motion of the anchor and stabilizer in response to the weight of a human user. Other examples of suitable rotation locks include a ratchet-and-pawl device or a rotatable compression rod.

The use of lock apertures 194, in embodiments utilizing a lock rod 194, allows pre-set configurations to adjust to multiple roof pitches. The preferred locking positions are 82.5 degrees and 75 degrees. It is the configurations of the various lock apertures that ensure that the angle between the anchor 116 and stabilizer 116 are at pre-set values. As shown by FIG. 11, the offset nature of the corresponding lock apertures generates a structural discrepancy that allows the generation of an angle. As the adjustable roof safety device is capable of latching to the edge of a roof, as well as the apex of a roof; the pre-set angles of the device will vary with its purpose. In embodiments configured to latch to a roof edge, it is preferred that the adjustable roof safety device 110 include pre-set limits involving much smaller angles to allow the anchor to clasp a soffit and the stabilizer to clasp the edge of the rooftop. The preferred pre-set angles for such embodiments include 30 degrees, 22.5 degrees, and 15 degrees; lock rod embodiments of the adjustable roof safety device have the lock apertures adjusted accordingly. FIG. 11 further exhibits the preferred means for attaching the adjustable roof safety device 110 to a roof edge, a body lock 150.

The body lock 150 of the present invention is a lock that keeps the body 112 stationary with respect to a roof. An embodiment of the body lock includes a rotatable compression rod that passes through the stabilizer 114 to contact a roof surface, or less preferably through the anchor 116 to contact a soffit. The compression rod of the preferred body lock includes a threaded rod that penetrates the stabilizer, which includes a threaded aperture to accept the threaded rod. A user would then screw the rod inward to urge the rod towards the interior of the device, or screw outward to release the body from its attached surface.

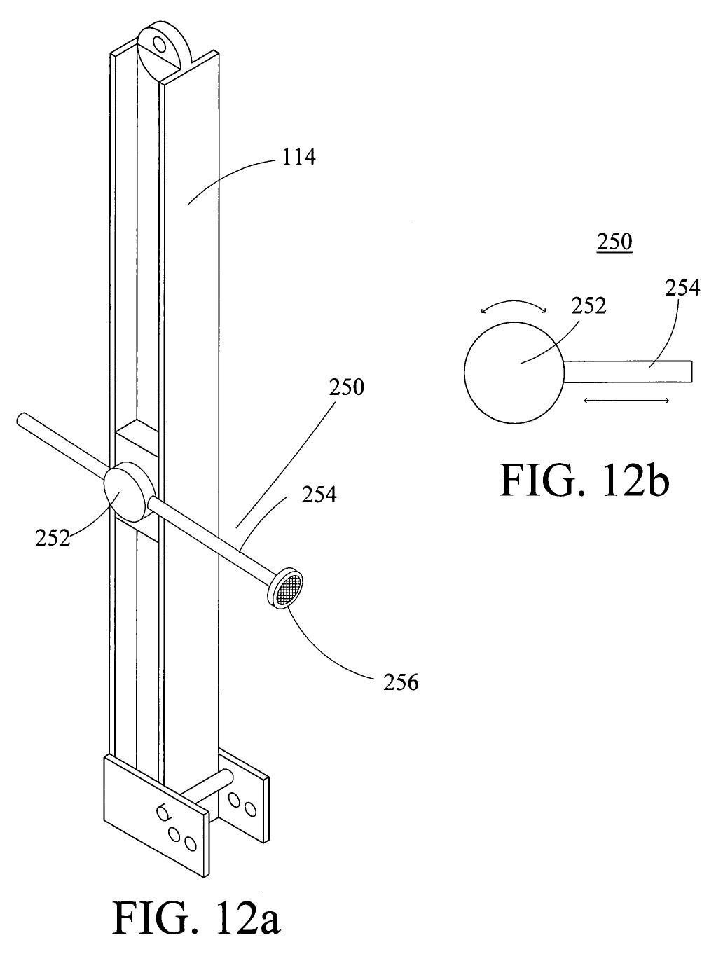

FIG. 12a illustrates an alternative embodiment of the body lock 250, with its preferred configuration relative to the stabilizer 114 of the present invention. The swinging body lock 250 includes three primary components: a wheel 252 attached to the stabilizer 114; an elevation rod 254 slidably affixed to the wheel; and a lock contact pad 256 affixed to the elevation rod 254. As shown in FIG. 12b, the wheel 252 moves radially about the stabilizer (not shown), while the elevation rod 254 is capable of longitudinal motion that can allow the elevation rod to pass through the body of the wheel 252. Returning to FIG. 12a, it can be seen that the swinging body lock 250 can adjust its position in two different ways, which allows the lock contact pad 256 to be more effectively positioned to contact the interior of a gutter. In use, the swinging body lock 250 would be rotated to be flush with the stabilizer 114 for ease of transport; upon setting the present invention on the edge of a roof, a user would place the stabilizer 114 on the top of the roof with the anchor (not shown) running beneath the rood proximate to a soffit. In addition to locking the angle of the stabilizer with respect to the anchor, a user could additionally swing the swinging rod lock 250 from its flush position into the nearby gutter, and position the elevation rod 254 to urge the lock contact pad 256 onto the inside surface of the gutter. It is preferred that the lock contact pad include a material dimensioned and adapted to either prevent scuffing the gutter or assist in preventing dislocation of the device.

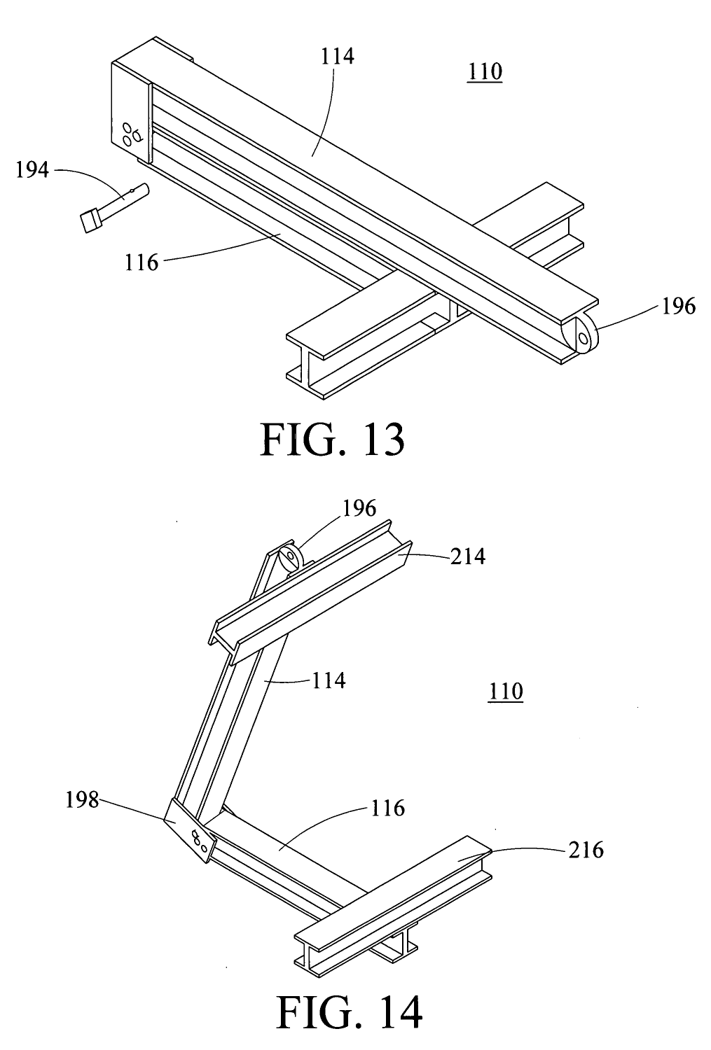

When the rotation lock of the present invention is released, or depressed as the case may be, the anchor and stabilizer are allowed free rotation about a plane with respect to each other. As shown by FIG. 13, a chief advantage of such rotation is the folding ability of the adjustable roof safety device 110.

Returning to FIG. 9, an embodiment of the adjustable roof safety device 110 comprises an anchor 116 that includes the frictional contact surface 118 of the present invention. Preferred versions of the adjustable roof safety device 110 will include an anchor 116 that further includes an anchor support 216. The purpose of the anchor support 216 is to increase the surface area of the anchor 116 capable of contacting a roof, or components in close proximity to the roof. The preferred configuration of the anchor support 216 is a transverse support beam at the end of the anchor 116. Such a configuration allows maximizes surface area while minimizing device length. Other embodiments of the present invention might further include a stabilizer support 214 as is shown in FIG. 14. The preferred stabilizer support 214 is a transverse support beam place on the interior surface (i.e. the surface of the device adapted to contact a roof) of the device 110. As FIG. 14 additionally shows, embodiments of the adjustable roof safety device 110 might include an alternate arrangement of the anchor support 216 placed on the interior surface of the anchor 116. The configuration of claim 13 is specially adapted to compensate for clearance of roof ridge vents.

It is preferred that the adjustable roof safety device 110 be constructed of aluminum I-beams to allow for structural integrity and portability. To further increase portability, internal portions the I-beams are removed; to further increase structural integrity, the I-beams could include additional welded-support within the interior. In embodiments that increase worker potential, the device 110 could include multiple harness attachment hookups 196 on the body.

Although the roof safety device, and kit of parts therefor, has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A low-profile roof safety device for grasping the apex of an angled roof, said device comprising:
a body having a stabilizer in planar rotatable attachment to an anchor;
a rotation lock adapted to statically engage said stabilizer and said anchor;
a frictional contact surface, disposed upon said body, dimensioned to statically engage a roof exterior; and
harness attachment means affixed to said body.

2. The device of claim 1 wherein said body further comprises an adjustment plate defining multiple apertures dimensioned to accept said lock, and wherein said anchor defines multiple apertures sized similar to said adjustment plate apertures.

3. The device of claim 2 wherein said anchor comprises a flush transverse anchor support.

4. The device of claim 2 wherein said anchor comprises an interior transverse anchor support.

5. The device of claim 4 wherein said stabilizer comprises an interior transverse stabilizer support.

6. The device of claim 5 wherein said body includes metal I-beams.

7. The device of claim 6 wherein said I-beams define multiple interior weight-reduction apertures.

8. A roof safety device for grasping the edge of a roof, said device comprising:
a body having a stabilizer in planar rotatable attachment to an anchor;
a rotation lock adapted to statically engage said stabilizer and said anchor;
a body lock, penetrating said body, for statically engaging a house surface; and
harness attachment means affixed to said body.

9. The device of claim 8 wherein said anchor comprises a flush transverse anchor support.

10. The device of claim 9 wherein said anchor comprises an interior transverse anchor support.

11. The device of claim 10 wherein said stabilizer comprises an interior transverse stabilizer support.

12. The device of claim 9 further comprising a frictional contact surface, disposed upon said body, dimensioned to statically engage a roof exterior.

13. The device of claim 12 wherein said body lock comprises a friction rod threadably penetrating said body.

14. A low-profile roof safety device for grasping the apex of an angled roof, said device comprising:
a metal body having a stabilizer in planar-rotatable, locking attachment to an anchor;
friction strips, disposed upon said body, dimensioned to statically engage a roof exterior; and
harness attachment means affixed to said body.

15. The device of claim 14 wherein said metal body comprises I-beams.

16. The device of claim 15 wherein said anchor comprises a flush transverse anchor support.

17. The device of claim 15 wherein said anchor comprises an interior transverse anchor support.

18. The device of claim 17 wherein said stabilizer comprises an interior transverse stabilizer support.
